(19) United States
(12) Patent Application Publication
(10) Pub. No.: US 2009/0006897 A1
(43) Pub. Date: Jan. 1, 2009

(54) AUTOMATED SERVICE TESTING

(75) Inventor: Bradley Brian Charles Sarsfield, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/769,172

(22) Filed: Jun. 27, 2007

(51) Int. Cl. G06F 11/00

(52) U.S. Cl. 714/38

(57) ABSTRACT

A service test case generation and execution system is provided that automatically generates one or more test cases for the service according to a service definition associated with the service. The service definition can specify one or more methods available in the service and/or one or more parameters for the methods. Additionally, sets or ranges of valid values can be specified for the parameters (such as in a web service description language (WSDL) definition). Test cases can be automatically generated based on this information, including specifying a plurality of valid and invalid input parameters, and automatically executed to provide testing of many code paths of a service. Output can also be measured in this regard.

### BACKGROUND

The evolution of computers and networking technologies from high-cost, low performance data processing systems to low cost, high-performance communication, problem solving, and entertainment systems has provided a cost-effective and time saving means to lessen the burden of performing every day tasks such as correspondence, bill paying, shopping, budgeting information and gathering, etc. For example, a computing system interfaced to the Internet, by way of wire or wireless technology, can provide a user with a channel for nearly instantaneous access to a wealth of information from a repository of web sites and servers located around the world. Such a system, as well, allows a user to not only gather information, but also to provide information to disparate sources. As such, online data storing and management has become increasingly popular.

Additionally, implementation of services to access such data have become more prevalent leading to development of technologies to facilitate such implementation. These technologies include web services, simple object access protocol (SOAP) used to access web services, web service description language (WSDL) specification to define available methods of a web service, and other similar technologies such as representational state transfer (REST), JavaScript object notation (JSON), and other remote procedure call (RPC) and service contract definition languages. Software developers can leverage these technologies to create service applications useable by consumers and administrators to access data, such as in a platform. Data access can include addition, deletion, modification, viewing, and the like. The technologies can present the service contract definition that defines one or more methods available by the service; a remote client can access the definition to initiate a request to the service for data access.

Because the services are utilized by a number of data consumers, extensive testing is typically desired, though not always executed to a great extent due to time and resources utilized in testing. Typically, testing of the developed service is performed by the developer and/or a quality group. The developer's knowledge is sometimes problematic to the task of testing since they know the different code paths and how to get there; for example, tests can be written based on expected result by the developer and not real world usage analysis. This can lead to insufficient testing, and thus, errors in some paths of the code left undiscovered. Additionally, testing of a service application can be lacking as it takes time to develop a test harness or other program/interface to test the application, and it typically also takes time of a tester to manually input values into the interface or the developer to code a plurality of different scenarios.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

A service test case generator is provided that can read a service definition to obtain information regarding a service application and automatically generate one or more test cases for the service application based on the definition. Once generated, the test cases can be automatically executed against the service application for testing thereof. For example, the service definition can comprise one or more method specifications relating to methods available in the service application; in addition, one or more input parameters (required and/or optional) can be specified corresponding to the method. The test case generator can utilize this information to create one or more test cases corresponding to the method and subsequently execute the test cases against the service application. Additionally, the service definition can provide one or more sets or ranges of valid values related to the parameters; this information can additionally be used to generate values within and outside of a valid range of values to test a substantial number of possible code paths for the method.

In one embodiment, the service application can be a web service providing access to data of a platform, for example. The web service can have an associated web service definition language (WSDL) specification describing the available method of the service and parameters/valid values associated therewith. The service definition can be consumed and a plurality of test cases produced based at least in part on each method in the WSDL specification. Test cases can also be created corresponding to many different combinations of valid and invalid parameter specifications according to the WSDL. Thus, for a given WSDL, many combinations and permutations of tests can be created and executed to test as many code paths as possible. To this end, the test cases can be executed via simple object access protocol (SOAP) call to the service and output can be measured in many different ways to provide information regarding the testing.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a block diagram of an exemplary system that generates test cases according to a service definition.

FIG. 2 illustrates a block diagram of an exemplary system that generates and executes test cases on a service.

FIG. 3 illustrates a block diagram of an exemplary system that provides output from test cases generated for and executed on a service.

FIG. 4 illustrates a block diagram of an exemplary service definition consuming component and a service test case generation component.

FIG. 5 illustrates a block diagram of an exemplary web service environment utilizing the automated test case generation/execution functionality.

FIG. 6 illustrates an exemplary flow chart for creating and executing one or more test cases corresponding to a service definition.

FIG. 7 illustrates an exemplary flow chart for determining parameter values to be used in generating test cases.

FIG. 8 illustrates an exemplary flow chart for executing a number of test cases against a service.

FIG. 9 is a schematic block diagram illustrating a suitable operating environment.

FIG. 10 is a schematic block diagram of a sample-computing environment.

### DETAILED DESCRIPTION

An automatic service testing architecture is provided to facilitate automatically testing services (such as web services, for example) and/or applications by running test cases against a service specifying a number of valid and invalid parameters in requests corresponding to the test cases and measuring responses from the requests. For example, the service can provide a service definition that describes available methods and parameters for the methods. Additionally, the service definition can provide valid bounds or entries for the parameters. Using this information, test cases can be built employing the various method calls with combinations of parameters; the parameters can be both valid and invalid according to the service definition to test for accuracy and/or desired results. The battery of test cases can be run against the service, and output can be gathered with respect to the test cases; the output can be validated with one or more expected results to provide feedback with respect to the service.

In one embodiment, a service definition consuming component can consume a service definition creating parameter test values from bounds and/or entries specified with respect to the parameters. A service test case generation component can begin to implement a plurality of test cases based on the parameter values created. The test cases can be executed serially and/or asynchronously such that a callback component can be employed to receive notice of return of the service call. To this end, computations and determinations can be made regarding the service calls. For example, a trip time can be calculated, a status code can be returned, etc., and this information can subsequently be pushed to a database, across a network wire, to a file (such as an extensible markup language (XML) file, text file, and the like), etc. The information can be employed by an administrator/developer and/or by an inference component, for example, to make inferences and/or recommendations with respect to the service.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

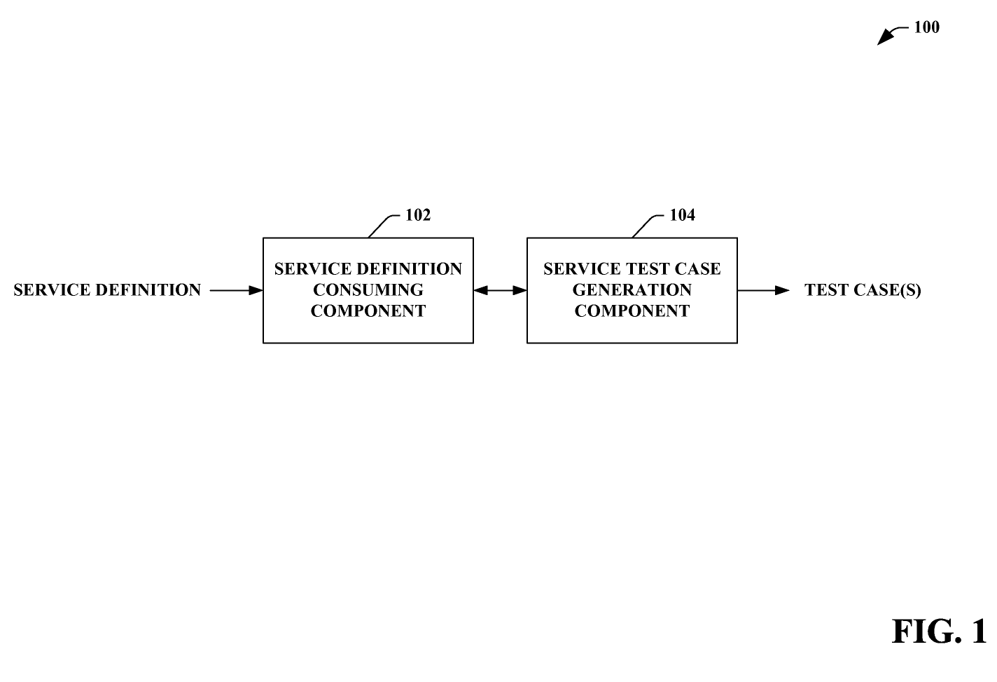

Now turning to the figures, FIG. 1 illustrates a system 100 that facilitates automatically testing services/applications according to a service definition. In particular, a service definition consuming component 102 is provided to receive and consume a service definition along with a service test case generation component 104 that can generate one or more test cases to utilize in testing the service. In one embodiment, the service has a service definition comprising specifications for utilizing the service. The service definition consuming component 102, for example, can receive and consume this definition and provide specifications to the service test case generation component 104. The service test case generation component 104 can utilize the specifications to discern one or more available methods as well as a plurality of input values and/or combinations of input values to use in testing the service. The test cases can be output from the service test case generation component 104 in substantially any form, such as to a database, a file, an execution engine, a display, and the like.

In one embodiment, the service definition can correlate to a service, such as a software service coded and executing in an environment (such as a web service or other service-oriented architecture, etc.). For example, the service can implement remote procedure call (RPC), representational state transfer (REST), or other type of service architecture. In this regard, the service definition can be a contract that describes functionalities of the service and how to utilize them. This contract can be implemented according to a web services description language (WSDL), JavaScript Object Notation (JSON), or other XML-based language definition syntax, for example; however, the disclosed subject matter is not limited to XML-based language definitions. In fact, many language definitions can be utilized, regardless of format, if it describes at least one input to utilizing the service (such as a method/function name and/or a parameter specification, for example). Some service definitions, such as WSDL, allow for bounding parameters; for example, a range can be specified for a given parameter. For instance, a parameter value can be an integer specifying that only values from 4-28 are valid entries.

The service definition consuming component 102 can receive the service definition by request, automatically on behalf of the service, or from a third-party, for example. The service definition can be consumed by the service definition consuming component 102 to determine the methods/functions that can be called as well as information regarding parameters for the methods/functions. This information can be sent to the service test case generation component 104 for creating of one or more test cases with which to test the service. The test case generation component 104 can generate the test cases based at least in part on the information from the service definition consuming component 102. In particular, the service test case generation component 104 can evaluate the functions/methods and the parameters associated therewith to create the test cases. A plurality of test cases for a given function(s) can be generated by specifying a number of different values for the parameters; the values can be determined based on the specification of valid parameter values, for example. In one embodiment, parameters for the test cases can be chosen by selecting and/or generating parameters both within and outside of the valid ranges as specified. For example, where 4-28 are specified as valid values for an integer parameter, the test case generation component 104 can choose to arbitrarily create test cases for the values −50, −15, 0, 3, 4, 10, 16, 27, 28, 29, 50, 1000, or the like.

It is to be appreciated that parameters can be chosen (and test cases generated) in real-time as well based at least in part on output received from one or more test cases. For example, if a test case in the above example generated an error for 50 and a different error for 1000, different values can be tested in between in attempt to identify the point of interruption. This can facilitate more convenient error detecting, for example. Additionally, the test cases can be generated in regard to a parameter relating to the test case generation component 104 for specifying a complexity for the test cases (in the previous example, a simple complexity can yield test cases for values 3, 4, 5, 27, 28, and 29, whereas a more complex test case specification can yield numerous other values, for example). Moreover, values can be selected that are within and outside of a type specification as well; for example, in the above case where the parameter is supposed to be an integer, strings (such as “dog”), booleans (true/false), and/or other variable types can be specified in some test cases to ensure the service's compliance with the service definition, for example. Furthermore, with respect to valid and invalid type tests, arrays having bounds can be tested with larger arrays (arrays having more elements than expected, for example) as well.

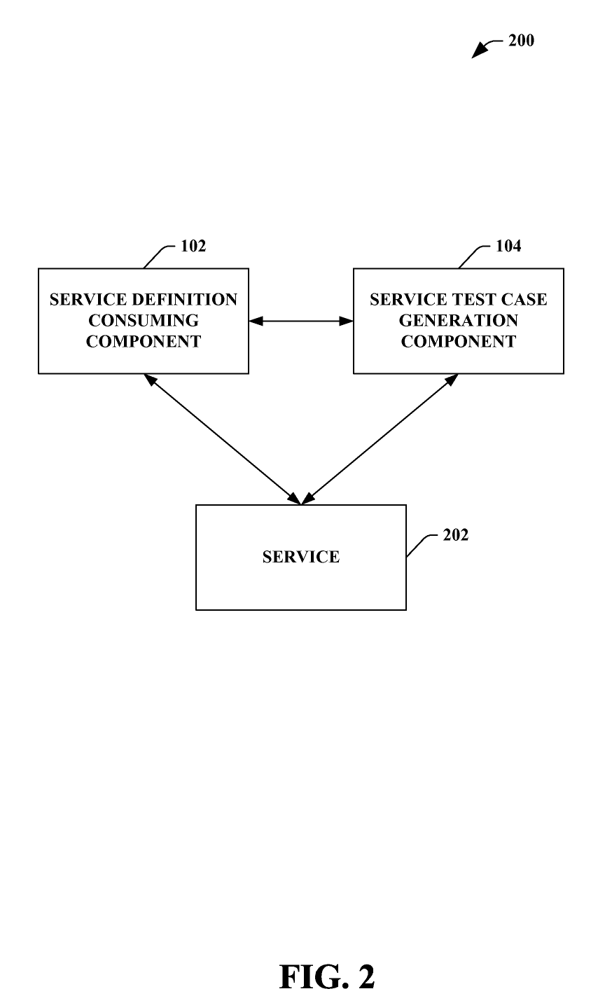

Referring to FIG. 2, a system 200 for automatically generating and executing one or more test cases for a service or application is shown. A service definition consuming component 102 is provided that takes a service definition corresponding to a service 202 as input. It is to be appreciated that the definition can come from the service 202 itself as pictured, in a request/response or subscription call, for example, and/or from a third-party component (not shown). A service test case generation component 104 is also provided to create one or more test cases based on the service definition and execute the test(s) on the service 202. In one embodiment, the service exposes the service definition, which comprises one or more methods available for execution by the service, as well as one or more parameter values that can be specified in conjunction with executing the service. It is to be appreciated that the method(s) are not limited to method(s) that specify parameters; rather the method can be such that it is invoked without parameter specification as well. The service definition can act as a contract between the service and an invoker such to specify the appropriate invocation of the method. The service definition consuming component 102 can consume the definition, or other indication of available methods/parameters, and send information to the service test case generation component 104 regarding the available methods and parameters. The service test case generation component 104 can utilize this information to create one or more test cases to test the methods and parameter specifications; the testing can be both inside and outside the range specification in the service definition, for example. The test cases can be subsequently executed on the service 202 by the service test case generation component 104, for instance.

As mentioned, the service definition can be of many formats so long as an available function and/or method is provided. Additionally, parameters can be provided for the functions/methods specifying input when calling the functions/methods. Moreover, in at least one embodiment, the parameters can be associated with a specification of valid parameters. This can be a type associated with the parameter (such as integer, string, and the like, and/or a complex type, such as a data structure), a range of valid values (such as 1-9 in an integer context), and/or an enumeration of valid values, etc. It is to be appreciated that the service definition can be strongly typed with respect to the service such that subsequent calls to the service according to the definition are checked for strict compliance before allowing the invoker to proceed. Additionally, however, the definition can act like more of a recommendation for values and the service can be responsible for handling input values outside of the service definition. In either case, the disclosed subject matter can test the service by specifying a plurality of values and combinations of values for the parameters and measuring output to make one or more determinations regarding the service (or simply output the output to a separate component, file, and/or the like). It is to be appreciated that the service definition can also describe the format of the output; this can be checked by the service test case generation component 104 for compliance, for example. Additionally, parameters of the service can be required and/or optional parameters.

In one embodiment, test cases can be created for each valid and invalid input as well as combinations thereof. For example, a test for a service with 4 parameters can be tested using the following combinations of valid (represented by 0) and invalid (represented by 1) parameters:

0000

0001

0010

0011

0100

0101

0110

0111

1000

1001

1010

1011

1100

1101

1110

1111

It is to be appreciated that multiple inputs can be provided for each combination such that the 0100 combination, for example, can have more than one test generated such that there can be multiple valid and invalid values for each parameter. It is to be appreciated that each permutation can be tested or a portion of the permutations available with the selected parameter values. For example, if each of the 4 parameters had 4 generated valid values and 3 generated invalid values, the 0100 combination can have 4*3*4*4=192 tests generated. Thus many total tests can be generated for a given tested service having multiple methods with multiple inputs, for example.

In one embodiment, the battery of tests can be generated by the service test case generation component 104 and executed against the service 202 by the service test case generation component 104. Output of the test case calls to the service 202 can be handled in many ways, such as sent back to the service test case generation component 104, output to a file, database, network wire, display, etc. Additionally, the service test case generation component 104 can utilize the output to create additional test cases. For example, inference and/or artificial intelligence can be used in this regard to create the additional tests based on the output. For example, the service 202 can be providing untimely results for a given input set and the service test case generation component 104 can detect this and find a threshold value for where the untimely results start to occur and provide an output of the value to the service 202 or another component, for example. Additionally, the service test case generation component 104 can execute the test cases sequentially, serially, and/or asynchronously specifying a callback location, for example.

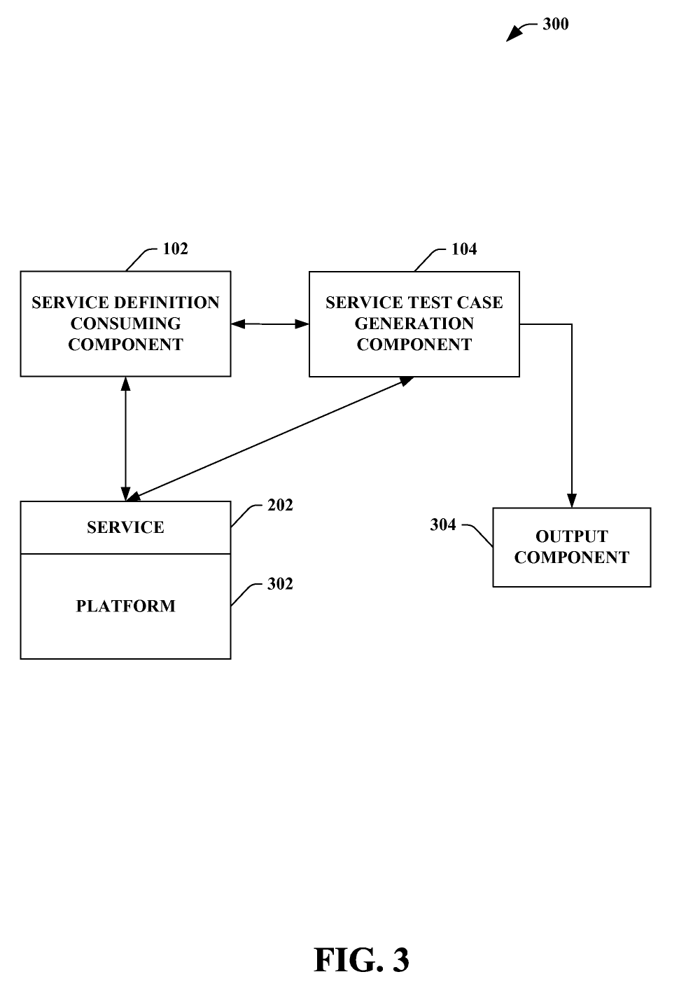

Turning now to FIG. 3, a system 300 for testing a service and providing output from the testing is displayed. In particular, a service definition consuming component 102 is provided to consume and generate data regarding a service definition for service 202. Service 202 can relate to a platform 302 and leverage the platform 302 for data access, storage, and/or manipulation, for example. Additionally, a service test case generation component 104 is provided to create and execute one or more tests on the service 202 and output results or other information relating to the tests to an output component 304. In one embodiment, the service definition consuming component 102 can receive a service definition for the service 202—the definition can originate from the service 202, the platform 302 related thereto, and/or another component, for example. The service definition consuming component 102 can consume the service definition and generate data regarding the available functions and parameters to be specified (as well as valid value bounds if specified in the definition). The service test case generation component 104 can create one or more test cases to be run against the service 202 and output results (of the tests or discerned results from the tests, for example) to the output component 304.

In one embodiment, the platform 302 can house data and provide access to add, delete, modify, and/or view the data. An example can be a financial institution account management service, a stock/news ticker service, an automobile part information platform, a platform for housing a plurality of health and fitness data, or substantially any platform that provides data access. The service 202 can facilitate the desired access to the data through a plurality of methods/functions. Use of the service can be tested accordingly as described above. In one embodiment, the service 202 can have a corresponding definition that provides information on accessing the service to provide access to the platform data. The service definition consuming component 102 can receive the service definition (e.g. from a push/pull request, subscribe request, event notification, etc.) and can create data for a service test case generation component 104. The service test case generation component 104 can create a plurality of test case scenarios for the service 202 (the service can be an application, for example) to test a variety of input values—e.g. both valid and invalid values as well as different combinations thereof. It is to be appreciated that the subject matter as described can be automated such that the service definition consuming component 102 need merely be given a location of a service; from there, the service definition can be received, consumed, and test cases can be generated by the service test case generation component 104. The test cases can be run and output from the service 202 to the output component 304 and/or from the service to the service test case generation component 104 for subsequent analysis and output to the output component 304, for example. In the latter case, the service test case generation component 104, for instance, can analyze the return data to make further determinations regarding the tests and/or to organize the data in a readable/analyzable format before outputting to the output component 304. It is to be appreciated that the test cases can be generated from data regarding the service definition such that valid and invalid values for parameters can be selected for each method/function, for example. One way to do this is to pick valid values (within a range for example) as well as values one unit below the low end of the range and one unit above the high end of the range. Other values can be chosen as well, and as described, the additional values can be based in part on results of previous test cases, for instance.

The output component 304 can be a file, database, display, network wire, and/or substantially any device or application able to receive data. In this regard, the data output to the output component 304 can be the results of the test case executions or a permutation thereof. For example, the data can report errors and/or unexpected results such that where invalid parameters are specified in the request, if a success comes back, this can be considered an error and reported as such. Thus, the output can be results of the tests (success/failure), a metric thereof (such as a graph or total number of disparate result codes, for example), detailed explanations of the failures and/or successes, time data (such as average request time), which can be broken up by input set, for example, and the like. In another embodiment, the service test case generation component 104 can operate with a service 202 and/or application having a generic service definition (such as one having only methods and parameters and no restriction on the parameters), or no explicit definition, for example. In this embodiment, the service test case generation component 104 can generate and execute batteries of test cases on the service 202 and generate a service definition based on the output. For example, if the output from the service 202 is failure or otherwise undesirable (such as an inefficient success, for example), the service test case generation component 104 can test the values for thresholds where the service produces desirable and undesirable results and introduce a recommended service definition based on the results and the values that caused the results via the output component 304, for example.

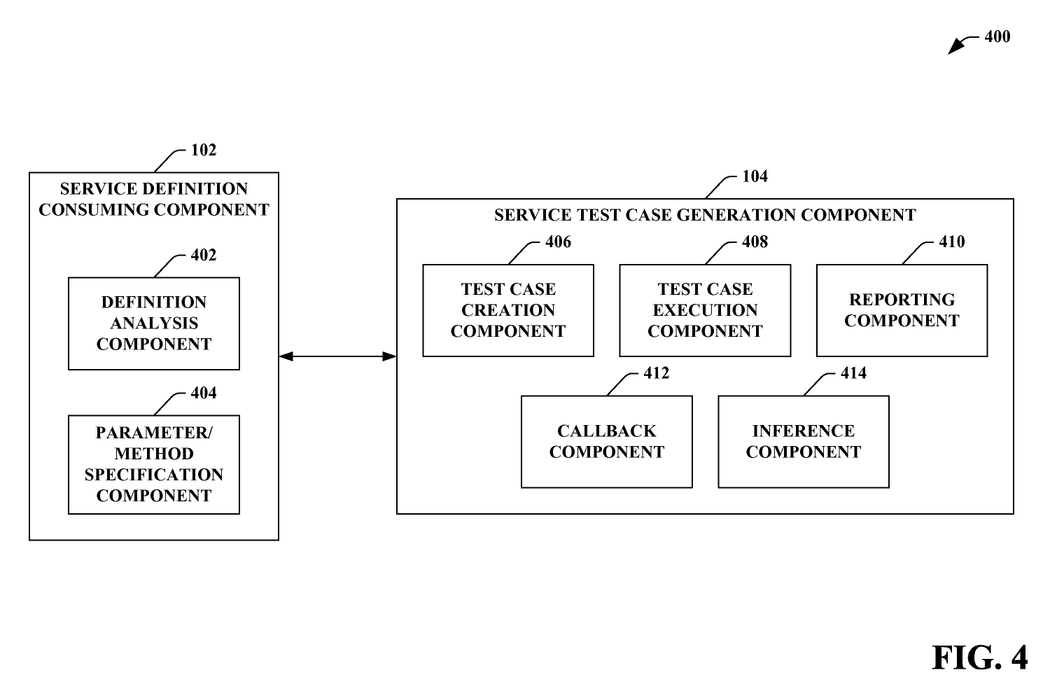

Referring now to FIG. 4, a system 400 that facilitates generating test cases from services based on a service definition is shown. A service definition consuming component 102 is provided having a definition analysis component 402 that can analyze a service definition, for example, as well as a parameter/method specification component 404 that can provide information regarding the analysis of the service definition component, such as parameter and method information, to a service test case generation component 104. The service test case generation component 104 can comprise a test case creation component 406 that can create one or more test cases to be executed based at least in part on the information received from the service definition consuming component 102, a test case execution component 408 that can execute one or more of the generated test cases, a reporting component 410 that can report and/or log data regarding execution of the test cases, a callback component 412 for asynchronous test case execution, and an inference component 414 for making one or more determinations based on execution of the test cases, for example.

In one embodiment, the service definition consuming component 102 can receive a service definition relating to a service that provides data access, for example. The definition analysis component 402 can consume and analyze the service definition to determine one or more methods offered by the service and/or parameters associated therewith. Additionally, other information can be determined from the definition if present, such as for example valid and invalid parameter value specifications. The analysis can produce data to be sent to the parameter/method specification component 404 that can create information regarding the analyzed available methods and parameters to be provided to a service test case generation component 104, for instance. The parameter/method specification component 404 can formulate data regarding methods available, their respective parameters (and bounds if present) and/or other information in a manner presentable to a service test case generation component 104, for example. The test case creation component 406 can utilize the information to create one or more test case scenarios utilizing the parameters and methods. The test cases can be created, for example, by evaluating the parameters of the methods and choosing values to challenge the parameters and ensure proper functionality as specified in the service definition. It is to be appreciated that parameters can be optional and/or required. The values chosen for the test cases can be both valid and invalid to test as many code paths as possible for the service. For example, the values for the parameters can be chosen based on a specification of valid and invalid parameters in the service definition. For instance, a parameter, such as an integer, can specify a valid and/or invalid range of values; the test case creation component 406 can choose parameters for the test cases according to the specified ranges such to include both valid and invalid values in an attempt to test as many code paths as possible. In another example, the parameter can be a string, for example, and specify an enumeration of possible values. Additionally, the parameter can be of a complex type comprising one or more simple and/or complex types. The complex types can also have valid and invalid specifications and can be tested accordingly. It is to be appreciated that many combinations of valid and invalid parameters choices can be tested alone or in conjunction with one another as described above. Additionally, the type of the parameter can be challenged (e.g. a string specified as input for an integer parameter).

The test case execution component 408 can execute the one or more test cases created by the test case creation component 406. The test cases can be ordered, for example, and required to execute in that order. This can be helpful, for example, in trying to pinpoint a threshold value causing an undesired result as described supra. Additionally, however, the order of testing can be left to the test case execution component 408. The tests can be executed sequentially, serially, and/or asynchronously (or a combination thereof). For asynchronous calls, a callback component 412 is provided to handle post service call processing. In serial or sequential calls, the test execution component 408 can handle the post service call processing or hand it off to another component. Such processing can include measuring values such as time of the request, result received, status code received, processing or memory/bandwidth consumed, code path taken, and/or the like. This information can be collated in a single source and/or used to make further determinations regarding the data and/or the service. For example, the information can be passed to the reporting component 410 where it can be processed and output, such as to a log file. Moreover, the reporting component 410 can output data to the network wire, a database, a display, etc. The reporting component 410 can additionally create other visual representations of the information, such as graphs and the like. In one embodiment, the output information is passed directly to the reporting component 410 for analysis. The reporting component 410 can additionally provide custom reports configured by an administrator, for example.

The information can also be sent to an inference component 414 for further analysis of the data to make determination and/or decisions regarding the testing of the service. As previously described, the inference component 414 can create one or more additional test cases based in part on information received from a previous test case—for example, to pinpoint a threshold value causing unexpected results. Using this and similar information, the inference component 414 can additionally make recommendations regarding the service, such as a change to the service definition to account for any problematic or unexpected results. For example, if an integer parameter of a service has specified a valid range of values between 1 and 10, but 1 does not produce a valid result or takes a significant amount of time compared to other values, the inference component 414 can detect this and offer this information, or even a new service definition limiting the values to 2-10, to the service, another component/application, and/or an administrator, for example. It is to be appreciated that the inference component 414 is not limited to the examples described, rather the inference component 414 can make many inferences from the output data of the test cases to improve the testing, the service, and/or the service definition, for example.

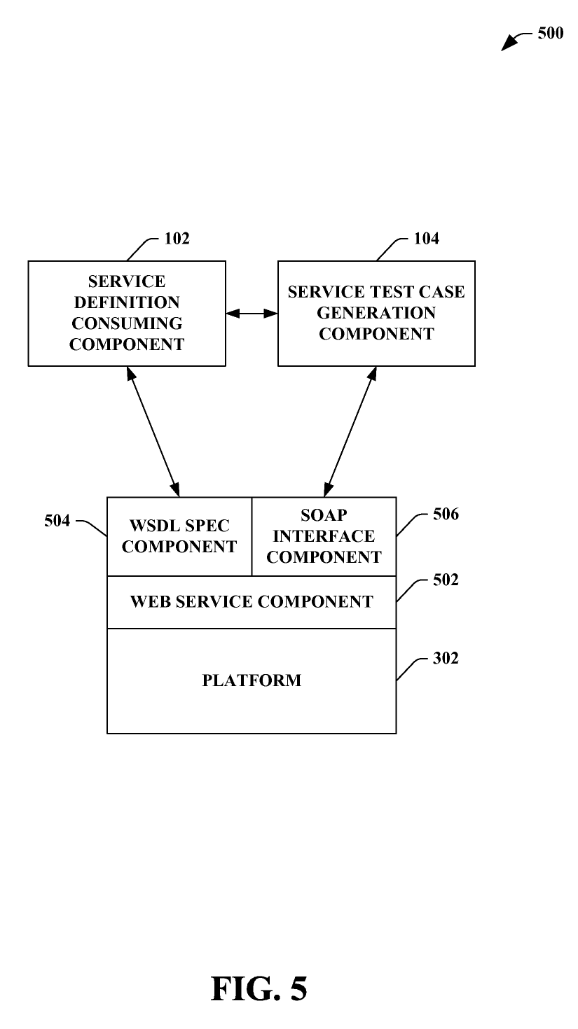

Now referring to FIG. 5, a system 500 is displayed that facilitates generating and executing test cases on a web service. In particular, a platform 302 can be provided comprising data and/or applications/devices that can access the data, for example. A web service component 502 can be provided to facilitate accessing data within the platform, such as for modification, addition, deletion, viewing, etc. Additionally, a web services description language (WSDL) spec component 504 can be provided to house and send a WSDL specification corresponding to the web service component 502; a service definition consuming component 102 is provided to receive and consume the WSDL specification. A simple object access protocol (SOAP—or service oriented architecture protocol) interface component 506 can also be provided to facilitate communication to the web service component; for example, a service test case generation component 104 can be provided to take advantage of such communication to test the web service component 502.

In one embodiment, the web service component 502 can offer access to one or more methods and/or data values in the platform 302; the methods and parameters for such can be outlined in a WSDL specification that acts as a contract for entities desiring access to the web service component 502. Accessing entities can utilize the WSDL specification to make requests to the web service component 502 as the specification provides information regarding utilizing the service such as how to call methods and valid types (and perhaps ranges or bounds) for the parameter values corresponding to the methods, etc. Additionally, the WSDL specification can inform a requesting entity of the return value of a method (if one exists), for example. The types of the parameters and return values can be simple (such as string, integer, boolean, float, memory pointer, and the like) or complex (a combination of simple and/or complex values). The WSDL specification can be obtained from the WSDL spec component 504 by a request/response mechanism, a subscribe request, a request from one object on behalf of another, and the like. The service definition consuming component 102 can request the WSDL specification from the WSDL spec component 504, for example. Upon receiving the WSDL specification, the service definition consuming component 102 can consume the specification to determine a list of available methods for the web service component 502 as well as parameters for the methods. It is to be appreciated that the parameters can be optional and/or required parameters. Additionally, valid values for the parameters can be specified in the WSDL specification, such as a range of valid and/or invalid values, an enumeration of valid/invalid values, etc. It is to be appreciated that the WSDL specification can specify one or more extensible markup language (XML) schema definition (XSD) type descriptions corresponding to the parameters and types thereof, for example.

Data regarding the WSDL specification can be sent to the service test case generation component 104; the data can be, for example, a data structure and/or array of structures representing the available methods and parameters. Additionally, the data can be a file and/or pointer to such information, raw data, binary data, or the WSDL specification itself. The service test case generation component 104 can generate one or more test cases based on the data. For example, the data comprises a plurality of callable methods along with specification of parameters for those methods; thus, the service test case generation component 104 can have sufficient information to generate one or more test cases to execute against the web service component 502. Additionally, the data can comprise valid/invalid parameter specifications as described; this information can also be used to create both valid and invalid parameters to test as many code paths of the web service component 502 (and/or platform 302) as possible.

Once the test cases are generated, the service test case generation component 104 can execute the tests by initiating method calls via SOAP objects. The SOAP objects can be created comprising the method call(s) and parameter specification(s) and sent to the SOAP interface component 506, where the SOAP object(s) is/are read and relevant information is extracted. The information can be sent to the web service component 502 for further handling. In one embodiment, the information comprises the requested method and parameter specifications, and the web service component 502 can execute the method with the parameters. Output from the method call can be wrapped in a SOAP object or envelope and sent back to the service test case generation component 104, for example. The service test case generation component 104 can also have a SOAP interface component and/or a SOAP reader (not shown) to interpret the object/envelope. Additionally, as described above, the service test case generation component 104 can output the data or other data inferred from the output data to another component, database, file, network wire, etc.

In one embodiment, the WSDL can be consumed by the service definition consuming component 102 from the WSDL spec component 504; this can entail enumerating through each method present in the WSDL noting the parameters and type required (and/or optional) to invoke the methods. Each parameter type can be enumerated as a simple or complex type as well (as mentioned, the types can be specified as XSD, for example). The simple type parameters can have valid and invalid ranges of data specified; as well, the complex types can be made up of simple or complex types (thus, eventually, a complex type is reducible to one or more sets of simple types). Therefore, valid and invalid values, whether a range, enumeration, or the like, can be determined for substantially all or some of the parameters even if complex in type. This information regarding the methods and types associated therewith can be sent to the service test case generation component 104 for the creation of test cases to execute against the web service component 502. The service test case generation component 104 can automatically generate values for the parameters based on the information from the WSDL spec; for example, both valid and invalid parameters can be purposely chosen, and output can be monitored accordingly. For example, if one invalid parameter is specified, an invalid status code can be expected, and if such is not received, the service test case generation component 104 can output the disparity. As described above, test cases can be created for substantially all combinations of the valid and invalid values chosen for a given method. In the example presented supra, taking 4 parameters for each of which 4 valid values and 3 invalid values were chosen, substantially all possible combinations of parameters could yield up to 7*7*7*7=2401 different test cases to execute. It is to be appreciated that the amount and/or complexity of parameters chosen for tests can be determined by parameters/settings of the service test case generation component 104 itself.

In one embodiment, valid parameter values can be chosen in a start, middle, and ending portion of a set or range of the valid values; however, the behavior can be modified through settings of the service test case generation component 104. Additionally, invalid values can be chosen based on values that do not follow the rules outlined in the WSDL specification. For example, invalid values can be chosen that are barely outside of the set or range (e.g. choosing 8 where the range is 1-7), values that are largely outside of the set or range (e.g. choosing 1,000,000 where the range is 1-7), or somewhere in between. Once the chosen values and combinations thereof have been executed on the chosen method, the service test case generation component 104 can move on to the next set. It is to be appreciated that the service test case generation component 104 can generate the tests as the preceding ones are executed, or generate the tests corresponding to an entire given WSDL specification, and then begin executing. Tests are executed by wrapping requests in a SOAP object and/or envelope and transmitting to the SOAP interface component 506. The SOAP interface component removes the request from the SOAP object and forwards it to the web service component 502 for processing thereof. Output from the web service component 502 can be communicated in the same way—wrapped in SOAP and sent to the service test case generation component 104. This output can be analyzed, a log file of the web service component 502 can be monitored, the service test case generation component 104 can keep statistics, and/or substantially any output resulting from the test case call to the web service component 502 can be evaluated. The output can be directly output to a file, database, display, network wire, etc., and/or the output can be analyzed to make further determinations regarding the data. For example, the service test case generation component 104 can time the calls; where calls for a certain set and/or combination of input takes longer than another, this can be reported as output. Additionally, system metrics can be measured, such as CPU processing and memory bandwidth. In this regard, possible denial of service attacks can be detected for given sets of input data, and such can be reported out as output. Moreover, the server hosting the web service component 502 (and/or platform 302) can be monitored for external affects of the calls such as server generated exceptions, data corruption, memory leaks, and/or the like. Furthermore, as described previously, the test output can be utilized to create additional tests based on one or more inferences made; tests can be re-executed as well, in this regard. Also, the output can be propagated as a recommended change to the WSDL specification to cover greater or lesser ranges depending on receiving more successes and/or failures than expected. As mentioned, in one embodiment, the disclosed subject matter can be pointed to a web service, and the testing process described above can be automated from that point.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent, for instance by inferring actions based on contextual information. By way of example and not limitation, such mechanism can be employed with respect to generation of materialized views and the like.

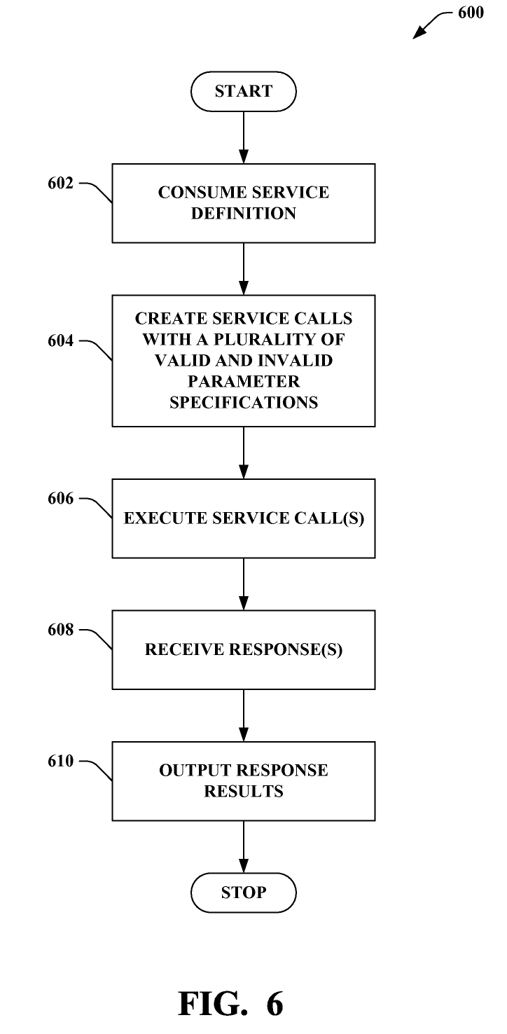

In view of the exemplary systems described supra, methodologies that may be implemented in accordance with the disclosed subject matter will be better appreciated with reference to the flow charts of FIGS. 6-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 6 shows a methodology 600 for generating and executing test cases on a service. As described, this can occur on services having a service definition that describes a protocol for communicating with the service; the protocol comprising available methods and parameters required (and optional) for the methods. At 602, the service definition is consumed. This can entail enumerating through the list of available methods and parameters therefor. The types of the parameters can be determined as well as valid value sets and ranges if specified. The types can be simple and/or complex (complex types can be one or more simple or complex types taken together to form a structure, for example). Thus, the complex types can be enumerated into one or more simple types by iterating through the type and any complex types of the complex type.

Once the methods and types are consumed, service calls can be created with a plurality of valid and invalid parameter specifications at 604. The valid and invalid parameters can be automatically generated for each method based on valid and/or invalid sets or ranges of values specified in the service definition. If no such sets or ranges exist, parameters can be chosen at random, or based on inference from similarly named parameters. For example, if a previous application had specified a parameter for DayOfWeek accepting inputs of 1-7 or enumerations corresponding to the different days of the week, inference can be used to associate a parameter for a disparate service to this previously tested parameter and use substantially the same input set to test the new parameter. Valid and invalid input sets can be specified based on one or more settings corresponding to the complexity and/or thoroughness of the test; thus, a high complexity and thoroughness setting can produce more test cases with more parameters than a lower setting, for example. Once the test cases are generated, they are executed at 606 against the service. The execution can occur sequentially, serially, and/or asynchronously (such that a callback function executes upon receiving a response). Additionally, the service calls can be executed as they are generated and/or after substantially all the calls are generated. At 608, responses are received from the calls; the response can correspond to the actual output from the service call and can specify, for example, one or more return parameters, a status code, etc. In the case of a status code, the code can be checked against a code expected; for example, if an invalid parameter is specified but a successful result was received. The service definition can define the format of the output as well which can ease result processing. At 610, response results can be output—this can be the raw results and/or results such as expressly identifying the aforementioned unexpected successful result. The results can be output to a file, database, display, network wire, etc., in substantially any format, such as a table of results sorted and/or sortable by one or more fields, an graph of execution time for the service calls, and the like.

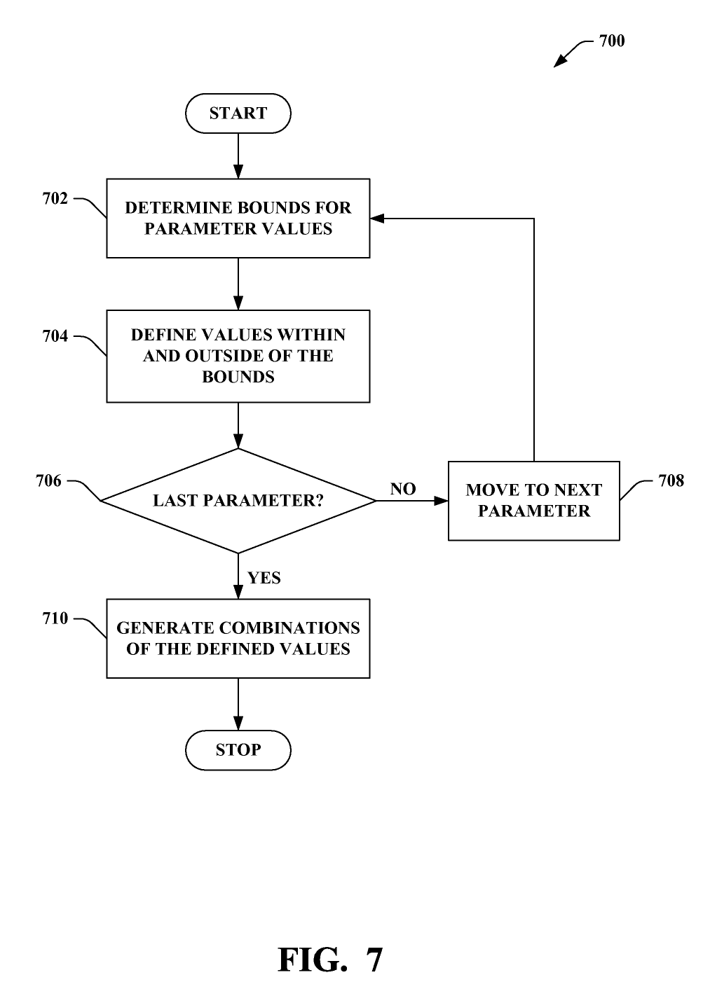

FIG. 7 illustrates a methodology 700 that facilitates enumerating through parameters for a method to generate one or more parameter values for test cases. A service definition can be received in accordance with examples and embodiments described above; the service definition can have bounds (a set or range) for valid/invalid parameter values, for example. At 702, the bounds are determined for a set of parameter values relating to a method in the service definition. The bounds can be specified as a set or range of valid and/or invalid parameters. At 704, values within and outside of the set and/or range are defined. The parameter values can be chosen in a variety of ways; for example, the valid values can be chosen at the beginning, middle, and end of the set/range of valid values, and the invalid values can be chosen as slightly outside of the set/range, far outside of the valid set/range, and/or somewhere in between. The number and severity of the parameters can be effectuated by a configuration setting for the subject matter as described. Where the bounds (set or range) represent invalid values, the converse can be true; the invalid values are chosen at the beginning, middle, and end of the range, and the a set of valid values can be chosen from slightly outside to far away from the invalid value specification.

After the values are defined, the parameter is checked to see if it is the last parameter at 706. If not, the next parameter is moved to at 708 and analyzed from 702. This loop can continue until the last parameter in the method is traversed. Once the last parameter is hit, combinations of the defined valid and invalid input values are generated at 710. The combinations can be generated for each permutation using each input value, for example. Thus, combinations can be generated for each valid and invalid input parameter value for each parameter—for large input sets, the number of combinations can become large. It is to be appreciated that the combinations generated can also be controlled by a configuration setting such that all combinations need not be generated in every case; rather a thoroughness setting can specify that a portion of the combinations should be executed in a test case.

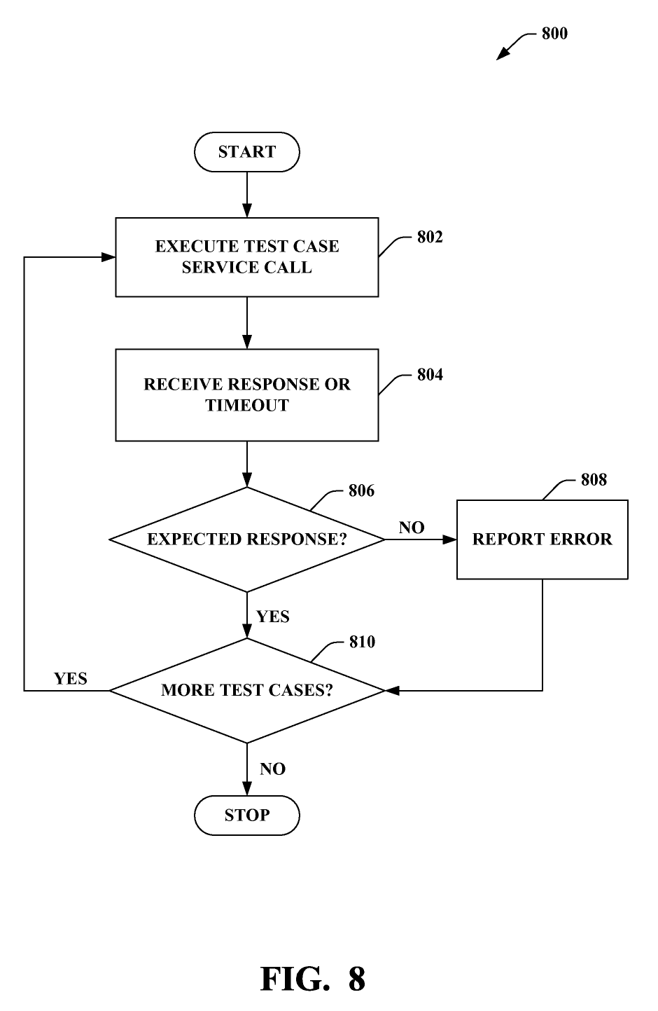

FIG. 8 shows a methodology 800 for executing one or more generated test cases on a service. Once the test cases are generated, they can be executed on the service at 802. Such execution can occur serially, such that a response or timeout is awaited before any other processing occurs, and/or asynchronously, such that a callback function can be specified to execute upon receiving a response while processing can continue (to execute another test case for example). At 804, a response or timeout is received. Additionally, the service can hang and a timeout can be forced. The response can return with a status code, for example, and/or one or more return parameters. The response can be checked against an expected response at 806. This can entail analyzing the return parameters and/or status code. For example, if all valid parameters were specified in the test case execution, a success can be expected; if at least one value was invalid, an invalid or error status can be expected. If a response is received to the contrary (or a timeout received where not expected), an error can be reported at 808. The error can be output to a file, database, display, network wire, or the like, for example. It can also be output singly, or aggregated with other errors to be reported in combination. Regardless of the response received, the method can continue to check for more test cases at 810. If more test cases are available, then they are executed at 802 again.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

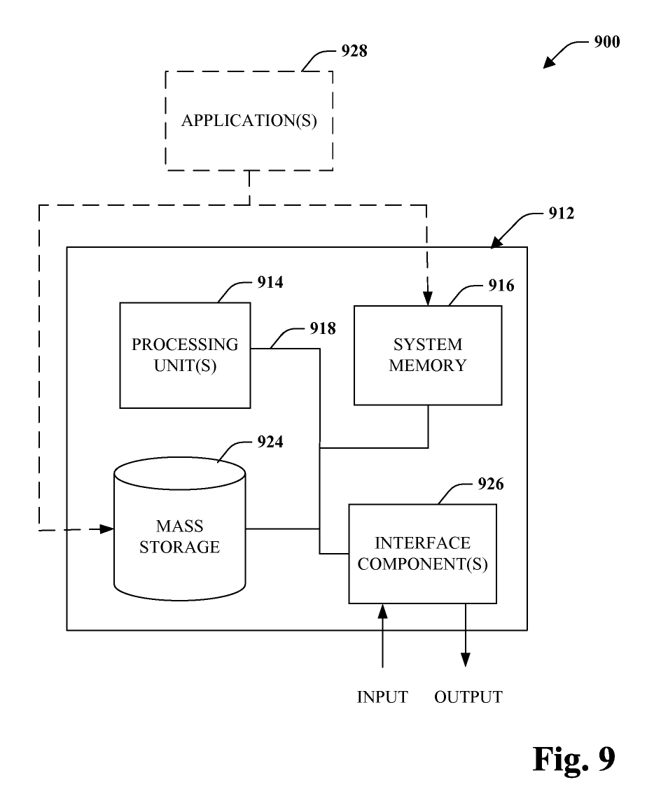

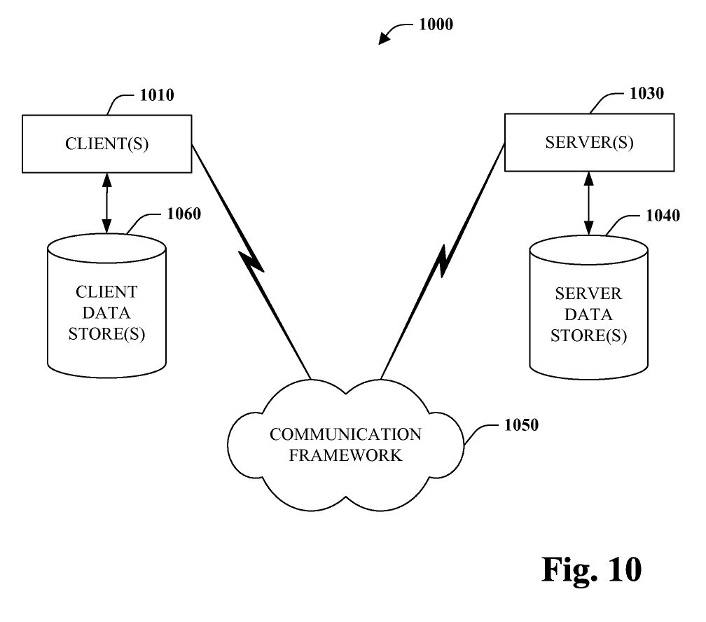

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 9, an exemplary environment 900 for implementing various aspects disclosed herein includes a computer 912 (e.g., desktop, laptop, server, hand held, programmable consumer or industrial electronics . . . ). The computer 912 includes a processing unit 914, a system memory 916 and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory or memory stick. In addition, mass storage 924 can include storage media separately or in combination with other storage media.

FIG. 9 provides software application(s) 928 that act as an intermediary between users and/or other computers and the basic computer resources described in suitable operating environment 900. Such software application(s) 928 include one or both of system and application software. System software can include an operating system, which can be stored on mass storage 924, that acts to control and allocate resources of the computer system 912. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., CRT, LCD, plasma . . . ), speakers, printers and other computers, among other things.

FIG. 10 is a schematic block diagram of a sample-computing environment 1000 with which the subject innovation can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. Here, the client(s) 1010 can correspond to program application components and the server(s) 1030 can provide the functionality of the interface and optionally the storage system, as previously described. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

By way of example, a service definition consuming component and a service test case generation component in accordance with the subject matter as described herein can be executed on or as clients 1010. The one or more server(s) can host a service and/or platform on which the service executes. The clients 1010 can request a service definition from the server(s) 1030, consume the service definition, and generate one or more test cases for the service. The test cases can then be executed against the server(s) 1030 via request made over the communication framework 1050, which can amount to calls to the service and/or platform; the call can cause the service and/or platform to obtain data from a data store 1040, for example. The service can complete one or more calls and send output back to the client(s) 1010 which can be stored in the client data store 1060, for example.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A system for automatically testing a service application, comprising:
a service definition consuming component that consumes one or more service definitions, the service definition comprises one or more methods available from a service application and one or more parameters related to the one or more methods; and
a service test case generation component that automatically generates one or more test cases associated with the service application based at least in part on the service definition.

2. The system of claim 1, the service definition further comprises a range of valid values corresponding to at least one of the parameters.

3. The system of claim 2, the one or more test cases are generated with at least one parameter value corresponding to the range of valid values.

4. The system of claim 3, the one or more test cases are generated with at least one parameter value corresponding to a value outside of the range of valid values.

5. The system of claim 1, the service test case generation component automatically executes the one or more test cases against the service application receiving a result therefor.

6. The system of claim 5, the service test case generation component sends the result out on a network.

7. The system of claim 5, the service test case generation component evaluates the result and generates an output inferred from the result, the output indicates a change recommended for the service application or the service definition.

8. The system of claim 5, the test cases are executed asynchronously.

9. The system of claim 1, the service application is a web service and the service definition is a web service definition language (WSDL) specification.

10. A method for automatically generating and executing test cases on service applications, comprising:
parsing a service definition related to functionalities offered by a service application;
generating one or more test cases automatically from the service definition, the test cases correspond to calling at least one function specified in the service definition and providing at least one parameter specified in the service definition; and
automatically executing the one or more test cases against the service application.

11. The method of claim 10, further comprising choosing one or more values for the at least one parameter, at least one chosen value is within a valid range specified for the parameter in the service definition.

12. The method of claim 11, at least one chosen value is outside of the valid range specified for the parameter in the service definition.

13. The method of claim 10, further comprising receiving one or more results associated with execution of the one or more test cases.

14. The method of claim 13, further comprising generating additional test cases to be executed based at least in part on the one or more results.

15. The method of claim 13, the result is output for presentation thereof.

16. The method of claim 10, further comprising measuring a system metric corresponding to the service application in conjunction with executing the one or more test cases.

17. The method of claim 16, the system metric is measured and output for presentation thereof.

18. A system for automatically testing a web service, comprising:
means for consuming a service definition related to a web service; and
means for automatically generating one or more test cases from the service definition.

19. The system of claim 18, further comprising means for executing the one or more test cases against the web service.

20. The system of claim 18, the service is a web service and the service definition is a web service description language (WSDL) definition.
